(19) United States
(12) Patent Application Publication
(10) Pub. No.: US 2013/0141930 A1
(43) Pub. Date: Jun. 6, 2013

(54) VEHICULAR HEADLAMP

(71) Applicant: Tetsuaki INABA, Shizuoka-shi (JP)

(72) Inventor: Tetsuaki INABA, Shizuoka-shi (JP)

(21) Appl. No.: 13/683,078

(22) Filed: Nov. 21, 2012

(30) Foreign Application Priority Data
Dec. 5, 2011 (JP) 2011-266108

(51) Int. Cl. B60Q 1/068; F21V 7/00

(52) U.S. Cl. CPC B60Q 1/0683; B60Q 1/068; F21V 7/00
USPC 362/516; 362/523; 362/524

(57) ABSTRACT

A vehicular headlamp includes: a lamp body that has a cylindrical portion having a front opening and a rear opening; a translucent cover that covers the front opening; a metallic light source base that has a light source installation portion, which is inserted from the rear opening to the lamp body and disposed therein; an annular elastic body coupling the lamp body to the light source base and closing a clearance between the lamp body and the light source base; and an optical axis adjustment mechanism coupling the lamp body to the light source base, wherein the light source base is supported so as to be turnable with respect to the lamp body by operation of the optical axis adjustment mechanism, and the elastic body is configured to be elastically deformed as the light source base is turned with respect to the lamp body.

### INCORPORATION BY REFERENCE

The disclosure of Japanese Patent Application No. 2011-266108 filed on Dec. 5, 2011 including the specification, drawings and abstract is incorporated herein by reference in its entirety.

### BACKGROUND OF THE INVENTION

1. Field of the Invention

The invention relates to a vehicular headlamp, and particularly relates to a structure of an optical axis adjustment mechanism.

2. Description of Related Art

Vehicular headlamps, in which a light source is disposed in a lamp chamber formed of a translucent cover and lamp body for example (for example, see Japanese Patent Application Publication No. 2007-207527 (JP 2007-207527 A)), have been available.

For example, the vehicular headlamp disclosed in JP 2007-207527 A is a fog lamp, in which a lamp body is formed in a generally cylindrical shape and an opening at a rear side of the lamp body is closed by a rear cover.

In such a vehicular headlamp, optical axis adjustment, that is, for example, aiming adjustment is necessary in some cases. By performing the aiming adjustment, a direction of the optical axis is adjusted to a desired direction, and light is radiated to a necessary area and it is made possible to prevent occurrence of dazzling light (glare light) to an oncoming vehicle, etc.

However, when an optical axis adjustment mechanism for adjusting the optical axis is provided in the vehicular headlamp disclosed in JP 2007-207527 A, it is necessary to fix an additional member, such as a bracket, to a vehicle body, and the overall vehicular headlamp is configured to be turnable with respect to the bracket. In addition, it is necessary to provide the optical axis adjustment mechanism with a structure for turning the overall vehicular headlamp with respect to the bracket.

Accordingly, it is necessary to provide another bracket for adjustment of the optical axis, which makes structure complicated.

### SUMMARY OF THE INVENTION

The invention provides a vehicular headlamp, in which a structure of a light adjustment mechanism is simplified.

A vehicular headlamp according to one aspect of the invention includes: a lamp body that includes a cylindrical portion having a front opening and a rear opening, wherein a central axis of the cylindrical portion extends along an optical axis of the headlamp; a translucent cover that covers the front opening; a light source base that has a light source installation portion, on which a light source is installed, and that is formed of metallic material, wherein at least the light source installation portion is inserted from the rear opening to the lamp body and disposed therein; an annular elastic body that couples the lamp body to the light source base and that closes a clearance between the rear opening of the lamp body and the light source base; and an optical axis adjustment mechanism for adjusting a direction of the optical axis, the optical axis adjustment mechanism coupling the lamp body to the light source base, wherein the light source base is supported so as to be turnable with respect to the lamp body by operation of the optical axis adjustment mechanism, and the elastic body is configured to be elastically deformed as the light source base is turned with respect to the lamp body.

With this configuration, there is no need to use a structure, in which an additional member, such as a bracket, is provided to turn the overall vehicular headlamp, for the optical axis adjustment, and thus a structure for the optical axis adjustment can be simplified.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a longitudinal section that shows an embodiment of a vehicular headlamp according to the invention together with FIG. 2 to FIG. 6;

FIG. 2 is a side view of the vehicular headlamp;

FIG. 3 is a longitudinal section that shows a state when an optical axis is adjusted, the longitudinal section being taken along a plane that is parallel with and offset from an optical axis of the vehicular headlamp;

FIG. 4 is a front view of the vehicular headlamp that shows a state where a translucent cover is removed;

FIG. 5 is a perspective view of a reflector; and

FIG. 6 is a longitudinal section of the reflector.

### DETAILED DESCRIPTION OF EMBODIMENTS

A description will hereinafter be made of an embodiment of a vehicular headlamp according to the invention with reference to accompanied drawings.

A vehicular headlamp 1 is, for example, a fog lamp that is attached to and disposed on each of right and left front end portions of a vehicle. It should be noted that in this specification and the claims, the terms indicating directions, such as front, rear, right, left, upward, and downward, mean the directions with respect to a vehicle when the headlamp is attached to the vehicle.

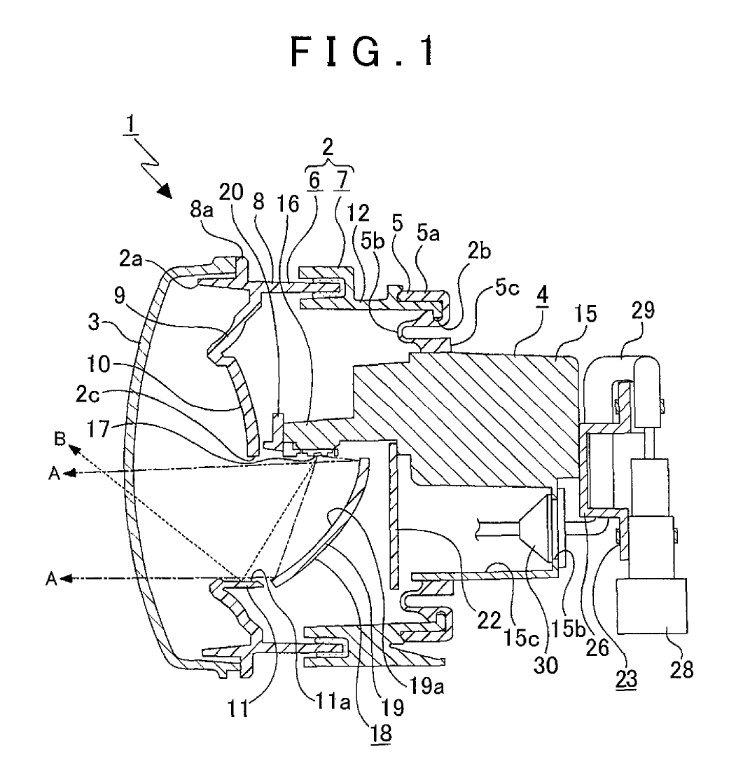

The vehicular headlamp 1 includes a lamp body 2, a translucent cover 3, a light source base 4, and an elastic body 5 (see FIG. 1 to FIG. 3).

The lamp body 2 is formed by joining a front member 6 and a rear member 7 in a front-rear direction, both of which are made of resin material.

The front member 6 is integrally formed of: a cylindrical portion 8 that is in a generally cylindrical shape and whose axial direction coincides with the front-rear direction; a first design portion 9 that juts inward from an inner peripheral surface of the cylindrical portion 8; a second design portion 10 that is provided so as to be continuous with an upper half of an inner peripheral edge of the first design portion 9; and a third design portion 11 that is provided so as to be continuous with a lower half of the inner peripheral edge of the first design portion 9.

An attachment flange 8a that juts radially outward is provided at a position in proximity to a front end of the cylindrical portion 8.

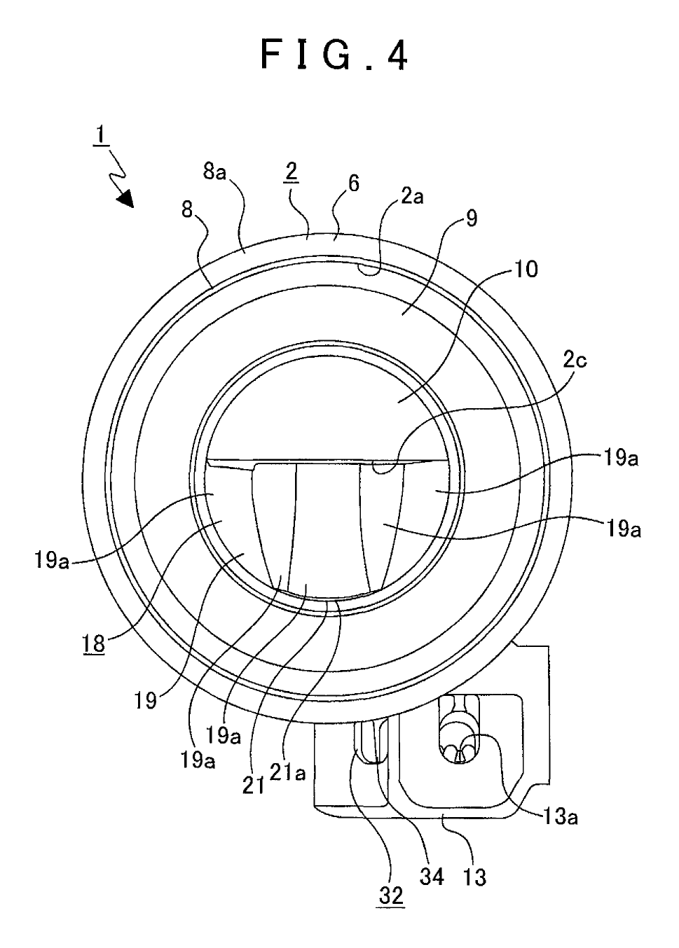

Each of the first design portion 9, the second design portion 10, and the third design portion 11 functions as an extension that hides each component located at the rear thereof. The first design portion 9 is formed in a generally annular shape when seen from the front (see FIG. 4), and is tilted so as to extend forward toward the inside (see FIG. 1). The second design portion 10 is formed in a semi-circular shape when seen from the front (see FIG. 4), and is formed in a gently curved shape that is convex rearward (see FIG. 1). The third design portion 11 is provided to jut rearward from an inner periphery of the second design portion 10. An inner surface 11a of the third design portion 11 is colored in black, is treated with light diffusion processing, or is given a light diffusion shape.

As shown in FIG. 1 to FIG. 4, the rear member 7 has a base portion 12 that is formed in a generally cylindrical shape, a tool insertion portion 13 that protrudes downward from the base portion 12, and a gear supporting portion 14 that is located at the rear of the tool insertion portion 13. A front end portion of the base portion 12 is joined to the rear end portion of the front member 6 by bonding, etc. An insertion hole 13a is formed in the tool insertion portion 13, penetrating in the front-rear direction (see FIG. 4).

The rear member 7 is provided with plural attachment protrusions (not shown) that protrude outward from an outer peripheral surface of the base portion 12. The plural attachment protrusions are each fixed to a vehicle body by a screw, etc. The base portion 12 is provided with a turnably supporting portion (not shown) at each of right and left sides on the inner side.

A front opening of the lamp body 2, that is, a front opening of the cylindrical portion 8 is formed as a front opening 2a, while a rear opening of the lamp body 2, that is, a rear opening of the base portion 12 is formed as a rear opening 2b (see FIG. 1). In the lamp body 2, a light passing opening 2c is also formed by a lower edge of the second design portion 10 and an opening edge at a lower half of the first design portion 9.

The translucent cover 3 is formed in a thin case shape that opens rearward and is attached to a lamp body 2 with a rear end surface of the translucent cover 3 abutting against the attachment flange 8a. In a state where the translucent cover 3 is attached to the lamp body 2, the front opening 2a and the light passing opening 2c are closed by the translucent cover 3.

The light source base 4 is formed of metallic material and functions as a heat sink. The light source base 4 has a coupling portion 15 and a light source installation portion 16 that protrudes forward from the coupling portion 15 (see FIG. 1 to FIG. 3). The coupling portion 15 is provided, on an upper end portion at a rear end portion thereof, with radiating fins 15a, 15a . . . that align in a right and left direction. Part of the light source base 4 that is a front end portion of the coupling portion 15 and the light source installation portion 16 is inserted from the rear opening 2b and located inside the lamp body 2.

An attachment hole 15b is formed in a lower end portion of the coupling portion 15, penetrating in the front-rear direction. A communication space 15c that communicates with the attachment hole 15b is formed inside the coupling portion 15.

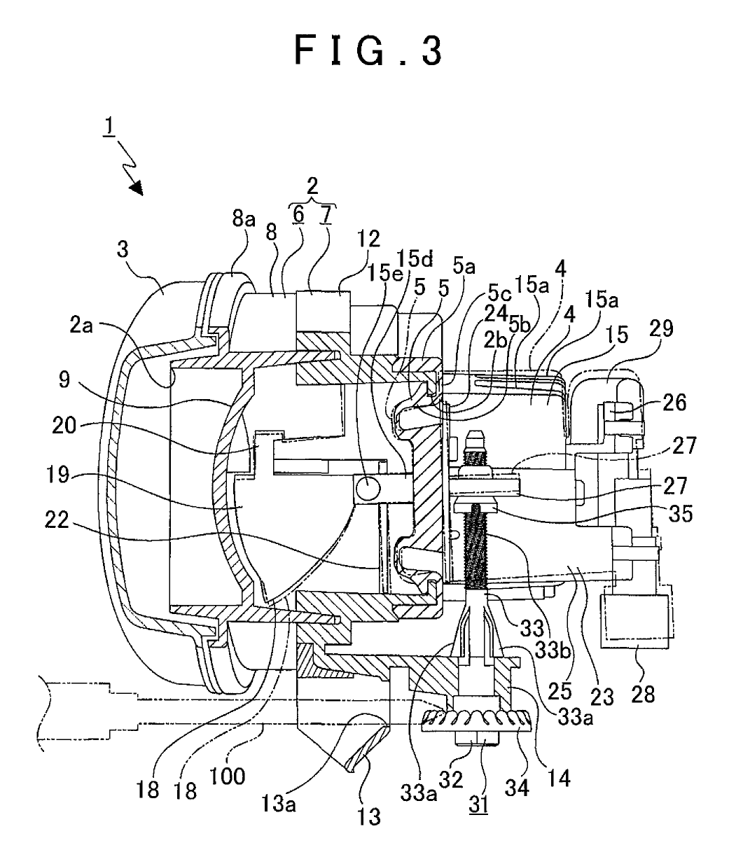

The coupling portion 15 is provided with supported protrusions 15d, 15d, each of which protrudes forward from corresponding one of the right and left sides (one supported protrusion 15d is shown in FIG. 3). Front end portions of the supported protrusions 15d, 15d are provided as pivot portions 15e, 15e, which are each supported by the turnably supporting portion that is provided in the base portion 12 of the rear member 7 in the lamp body 2. Accordingly, the light source base 4 is turnable generally in a vertical direction with respect to the lamp body 2 about the pivot portions 15e, 15e.

A light source 17 is attached to a lower surface of the light source installation portion 16. The light source 17 is a light-emitting diode (LED), for example, and is attached to the light source installation portion 16 in a direction such that light is emitted downward.

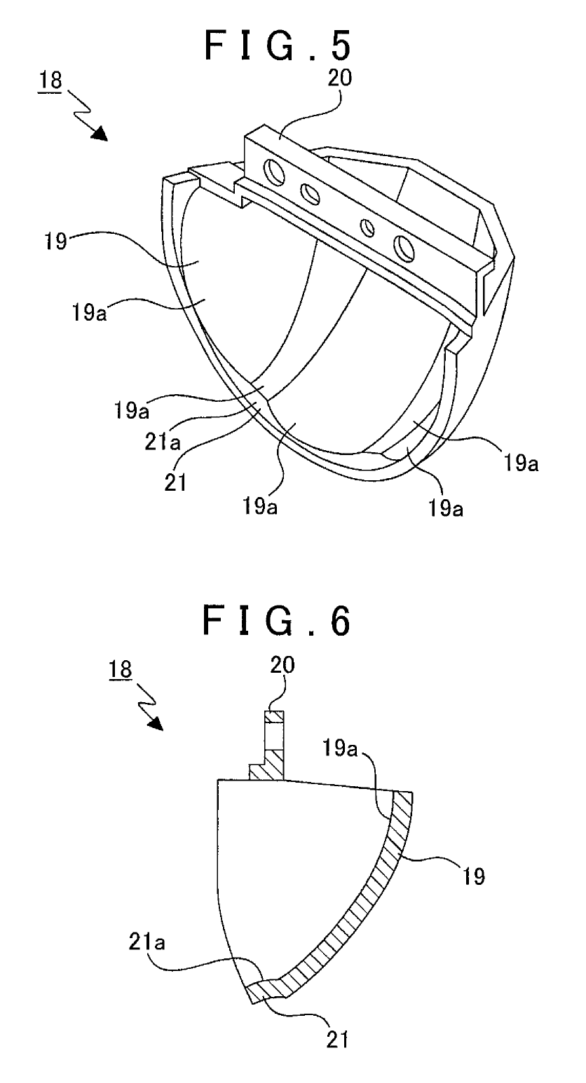

A reflector 18 is attached to the light source installation portion 16. As shown in FIG. 5, the reflector 18 is formed of a reflection portion 19 formed in a curved shape that is convex outward (in a generally paraboloid-of-revolution shape), an attachment portion 20 that spans between a right end portion and a left end portion on an upper surface of the reflection portion 19, and a projection 21 that is provided so as to continuous with a lower edge of the reflection portion 19 and that is small in width in the front-rear direction.

The reflector 18 is formed so that an inner surface of the reflection portion 19 is divided into plural areas of reflecting surfaces 19a, 19a . . . that reflect, to the front, the light emitted by the light source 17. The projection 21 is formed in a horizontally long shape that faces in the generally vertical direction, and an upper surface of the projection 21 is formed as a gently curved surface 21a that is convex generally upward and that diffuses the light emitted by the light source 17 (see FIG. 6).

The attachment portion 20 of the reflector 18 is attached to a front surface of the light source installation portion 16 by a screw, etc. (see FIG. 1). In a state where the reflector 18 is attached to the light source installation portion 16, the reflection portion 19 and the projection 21 are located below the light source installation portion 16, and a front surface of the reflector 18 is located to face and be in proximity to a rear end of the third design portion 11 of the front member 6.

As described above, the light source 17 and the reflector 18 are attached to the light source base 4 and thus are turned along with the turning of the light source base 4 with respect to the lamp body 2.

A circuit board 22 is disposed at the rear side of the reflector 18. The circuit board 22 is attached to the light source base 4 and is located forward of the communication space 15c. The circuit board 22 is connected to the light source 17 by wiring (not shown).

The elastic body 5 is formed in an annular shape, and as shown in FIG. 1, the elastic body 5 is integrally formed of an outer joined portion 5a that is joined to the rear end portion of the rear member 7 so as to be in close contact with the rear end portion of the rear member, an inner joined portion 5b that is joined to an outer peripheral surface of the coupling portion 15 so as to be in close contact with the outer peripheral surface of the coupling portion 15, and a thin portion 5c that connects the outer joined portion 5a to the inner joined portion 5b, the elastic body 5 being made of elastic material, preferably made of polymer material, such as rubber.

In a state where the elastic body 5 is attached to couple the lamp body 2 to the light source base 4, a clearance at the rear opening 2b of the lamp body 2 between the rear member 7 and the coupling portion 15 is closed by the elastic body 5.

A holding member 23 is fixed to the coupling portion 15 of the light source base 4 by a screw, etc. (see FIG. 1 to FIG. 3). The holding member 23 has a plate-shaped attachment surface 24 that faces in the front-rear direction, a plate-shaped intermediate portion 25 that protrudes rearward from a side edge of the attachment surface 24, and a holding portion 26 that protrudes laterally from a rear edge of the intermediate portion 25. A plate-shaped coupling piece 27 that faces the vertical direction is provided on the holding member 23 so as to extend from the attachment surface 24 and the intermediate portion 25, and a coupling hole is formed in the coupling piece 27, penetrating vertically.

In the holding member 23, for example, the attachment surface 24 and the holding portion 26 are fixed to the coupling portion 15 by a screw, etc. A connector 28 that is connected to a power supply circuit (not shown) is held by the holding portion 26 of the holding member 23. A connection cable 29 is drawn from the connector 28 and is connected to the circuit board 22 via the communication space 15c in a state where an intermediate portion of the connection cable 29 is held by a cable holding body 30 that is attached to the attachment hole 15b.

Accordingly, driving electric current is supplied from the power supply circuit to the light source 17 via the connector 28, the connection cable 29, and the circuit board 22, whereby light is emitted by the light source 17. When the light is emitted by the light source 17, heat is externally radiated from the light source base 4, which functions as the heat sink, and particularly from the radiating fins 15a, 15a . . . .

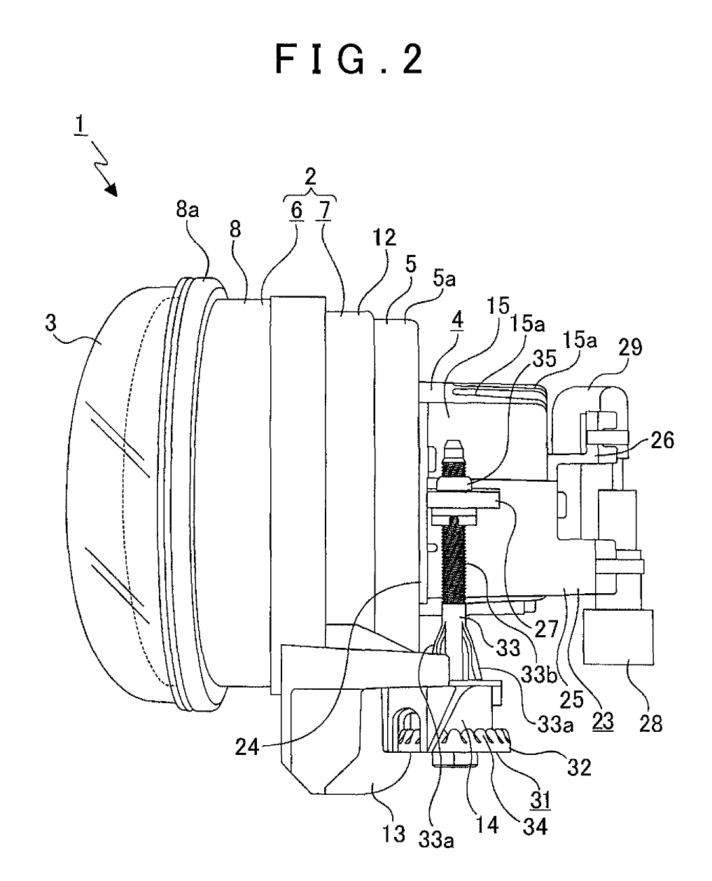

The vehicular headlamp 1 is provided with an optical axis adjustment mechanism 31, and the optical axis adjustment mechanism 31 has an aiming screw 32 (see FIG. 2 and FIG. 3).

The aiming screw 32 is rotatable in a state where the gear supporting portion 14 of the rear member 7 is coupled to the coupling piece 27 of the holding member 23. The aiming screw 32 is formed of a shaft portion 33 that extends vertically and a gear portion 34 that juts radially outward from a lower end portion of the shaft portion 33.

Engagement portions 33a, 33a that jut radially outward are provided in positions in proximity to the lower end of the shaft portion 33, and part of the shaft portion 33 other than both the upper and lower end portions of the shaft portion 33 is provided as a thread portion 33b. The thread portion 33b of the aiming screw 32 is screwed into a nut member 35 that is attached to the coupling piece 27.

The lower end portion of the shaft portion 33 of the aiming screw 32 is coupled to the gear supporting portion 14, and the thread portion 33b thereof is coupled to the coupling piece 27 via the nut member 35.

The vertical movement of the aiming screw 32 with respect to the gear supporting portion 14 is restricted by the gear portion 34 and the engagement portions 33a, 33a. When the aiming screw 32 is rotated about an axis of rotation, and thus the thread portion 33b is translated with respect to the nut member 35, the light source base 4 is turned in the generally vertical direction with respect to the lamp body 2 about the pivot portions 15e, 15e (see FIG. 3). Accordingly, when the light source base 4 is turned in the generally vertical direction with respect to the lamp body 2, the direction of the optical axis is changed, whereby aiming adjustment is made. The aiming adjustment can be done by inserting a tool 100 such as a screwdriver to the insertion hole 13a that is formed in the tool insertion portion 13 of the lamp body 2, engaging the tool 100 with the gear portion 34 for turning, and rotating the aiming screw 32.

When the optical axis adjustment (the aiming adjustment) is made, the elastic body 5 is elastically deformed as the light source base 4 is turned with respect to the lamp body 2.

In the vehicular headlamp 1 that is configured as described above, the elastic body 5 is shielded from the front by the first design portion 9 of the lamp body 2, the light source base 4 and the light source 17 are shielded by the second design portion 10, and a front portion of the front surface of the reflector 18 is shielded by the third design portion 11.

The light emitted by the light source 17 is reflected by the reflecting surfaces 19a, 19a . . . of the reflector 18 and then passes through the translucent cover 3 to be radiated to the front (the light A shown in FIG. 1). At this time, the light emitted by the light source 17 partially reaches an inner surface of the third design portion 11. However, as described above, the inner surface 11a of the third design portion 11 is colored in black, is treated with the light diffusion processing, or is given the light diffusion shape.

Accordingly, because the light that reaches the third design portion 11 is absorbed or diffused by the third design portion 11, occurrence of the light that is directed upward (the light B shown in FIG. 1) is reduced. Therefore, it is possible to suppress occurrence of dazzling light to an oncoming vehicle, etc.

In addition, there is no need to provide a blocking portion that blocks the light directed to the third design portion 11 in proximity to the light source 17 in order to suppress the occurrence of dazzling light, and because of this, the usable areas of the reflecting surfaces 19a, 19a . . . of the reflector 18 can be increased. Furthermore, efficiency for utilization of the light emitted by the light source 17 can be improved.

The projection 21 of the reflector 18 is provided for a purpose of forming the plural reflecting surfaces 19a, 19a . . . to obtain required distribution patterns of the light emitted by the light source 17. As described above, the upper surface of the projection 21 is formed as the gently curved surface 21a that is convex in the generally upward direction so as to diffuse the light emitted by the light source 17.

Accordingly, because the light that is emitted by the light source 17 and reaches the projection 21 is diffused by the curved surface 21a, the occurrence of the reflected light that is directed upward is reduced, and thus it is possible to suppress the occurrence of the dazzling light to an oncoming vehicle, etc.

In the vehicular headlamp 1, because the light passing opening 2c is formed by the lower edge of the second design portion 10 and the opening edge at the lower half of the first design portion 9, various portions that are disposed inside of the vehicular headlamp 1 are hidden by the first design portion 9 and the second design portion 10. Thus, the light reflected by the reflector 18 can appropriately be radiated to the front without impairing the design of the vehicular headlamp 1.

As it has been described so far, the vehicular headlamp 1 is provided with the optical axis adjustment mechanism 31 that couples the lamp body 2 to the light source base 4. The light source base 4 is supported so as to be turnable with respect to the lamp body 2 by operation of the optical axis adjustment mechanism 31, and the elastic body 5 is configured to be elastically deformed as the light source base 4 is turned with respect to the lamp body 2.

Accordingly, there is no need to adopt a structure in which an additional component such as a bracket is provided to turn the entire vehicular headlamp 1 for the optical axis adjustment, and thus the structure for enabling the optical axis adjustment can be simplified.

Furthermore, the annular first design portion 9 that hides the elastic body 5 from the front and juts inward from the cylindrical portion 8 is provided, and the first design portion 9 and the cylindrical portion 8 are integrally formed of resin material. Therefore, the elastic body 5 is hidden without increasing the number of parts.

Moreover, because the lamp body 2 is formed by joining the front member 6 with the rear member 7, it is possible to assemble the lamp body 2 by joining the front member 6 to the rear member 7 in a state where the rear member 7 is joined to the light source base 4 via the elastic body 5. Therefore, the ease of attachment of the front member 6 that is provided with the first design portion 9 and the second design portion 10 is improved.

The above description illustrates an example of an optical system in which the light reflected by the reflector 18 passes through the translucent cover 3 to be radiated to the front. However, as the optical system for the vehicular headlamp, for example, an optical system of a direct emission type that does not have a reflector or an optical system in which a lamp unit having a projection lens and a reflector is disposed in a lamp casing that is formed of an outer cover and a lamp housing may be adopted.

An optical system may be adopted in which another light source than the light source 17 is disposed in front of the second design portion 10.

The above description illustrates an example of the optical system in which the reflection portion 19 of the reflector 18 is located below the light source 17. However, an optical system may be adopted in which a reflection portion of a reflector is located above or to a side of a light source and in which the light is emitted upward or laterally by the light source and reflected by the reflector to be radiated to the front.

The above description illustrates an example in which the vehicular headlamp 1 is a fog lamp. When the vehicular headlamp 1 is a fog lamp, as described above, it suffices that the optical axis adjustment (the aiming adjustment) can be made in the vertical direction. However, when the vehicular headlamp 1 is a headlamp, a structure is adopted that enables the optical axis adjustment in both the vertical direction and the lateral direction.

The lamp body may include an annular first design portion that juts inward from the cylindrical portion and that hides the elastic body from the front, and the first design portion and the cylindrical portion may be integrally formed of resin material.

With this configuration, the elastic body is hidden without increasing the number of parts.

The vehicular headlamp may further include a reflector that reflects, to the translucent cover, light emitted by the light source, wherein the lamp body has a second design portion that is continuous with the first design portion and that hides the light source base and the light source from the front, and a light passing opening, through which the light reflected by the reflector passes, is defined by inner peripheral edges of the first design portion and the second design portion.

With this configuration, the light reflected by the reflector can appropriately be radiated to the front without impairing the design of the vehicular headlamp.

The lamp body may include a third design portion that is continuous with the first design portion and that extends from an opening edge of the light passing opening toward a front end edge of the reflector, and a surface of the third design portion that faces the light source may be colored in black, be treated with light diffusion processing, or be given a light diffusion shape.

With this configuration, because the light that reaches the third design portion is absorbed or diffused by the third design portion, it is possible to restrict the occurrence of dazzling light to an oncoming vehicle, etc.

Part of an outer periphery of an inner surface of the reflector may be formed to be a curved surface that diffuses the light emitted by the light source.

With this configuration, because the light emitted by the light source is diffused by the curved surface, it is possible to restrict the occurrence of dazzling light to an oncoming vehicle, etc.

The lamp body may be formed by joining, in a front-rear direction, a front member that has the front opening and a rear member that has the rear opening.

With this configuration, the lamp body can be assembled by joining the front member and the rear member in a state where the rear member is joined to the light source base via the elastic body, and thus the ease of assembling of the lamp body can be improved.

The shapes of the components and structures in the above-described embodiment of the invention are merely examples to embody the invention, and the technical scope of the invention should not be limited to the above-described embodiment.

What is claimed is:

1. A vehicular headlamp comprising:
a lamp body that includes a cylindrical portion having a front opening and a rear opening, wherein a central axis of the cylindrical portion extends along an optical axis of the headlamp;
a translucent cover that covers the front opening;
a light source base that has a light source installation portion, on which a light source is installed, and that is formed of metallic material, wherein at least the light source installation portion is inserted from the rear opening to the lamp body and disposed therein;
an annular elastic body that couples the lamp body to the light source base and that closes a clearance between the rear opening of the lamp body and the light source base; and
an optical axis adjustment mechanism for adjusting a direction of the optical axis, the optical axis adjustment mechanism coupling the lamp body to the light source base, wherein
the light source base is supported so as to be turnable with respect to the lamp body by operation of the optical axis adjustment mechanism, and
the elastic body is configured to be elastically deformed as the light source base is turned with respect to the lamp body.

2. The vehicular headlamp according to claim 1, wherein
the elastic body includes an outer joined portion that is joined to a rear end portion of the lamp body so as to be close contact with the rear end portion of the lamp body, an inner joined portion that is joined to an outer peripheral surface of the light source base so as to be close contact with the outer peripheral surface of the light source base, and a thin portion that connects the outer joined portion to the inner joined portion, and the outer joined portion, the inner joined portion, and the thin portion are integrally formed.

3. The vehicular headlamp according to claim 1, wherein
the lamp body includes an annular first design portion that juts inward from the cylindrical portion and that hides the elastic body from the front, and
the first design portion and the cylindrical portion are integrally formed of resin material.

4. The vehicular headlamp according to claim 1, further comprising
a reflector that reflects, to the translucent cover, light emitted by the light source, wherein
the lamp body includes a second design portion that is continuous with the first design portion and that hides the light source base and the light source from the front, and
a light passing opening, through which the light reflected by the reflector passes, is defined by inner peripheral edges of the first design portion and the second design portion.

5. The vehicular headlamp according to claim 4, wherein
the lamp body includes a third design portion that is continuous with the first design portion and that extends from an opening edge of the light passing opening toward a front end edge of the reflector, and
a surface of the third design portion that faces the light source is colored in black, is treated with light diffusion processing, or is given a light diffusion shape.

6. The vehicular headlamp according to claim 4, wherein
part of an outer periphery of an inner surface of the reflector is formed to be a curved surface that diffuses the light emitted by the light source.

7. The vehicular headlamp according to claim 1, wherein
the lamp body is formed by joining, in a front-rear direction, a front member that has the front opening and a rear member that has the rear opening.

8. The vehicular headlamp according to claim 1, wherein
the optical axis adjustment mechanism includes an aiming screw having: a shaft portion having a thread portion; and a gear portion and an engagement portion that are provided at one end portion of the shaft portion and jut radially outward;
the thread portion is screwed into a nut member that is attached to a coupling piece provided on the light source base; and
at the one end portion of the shaft portion, a gear supporting portion provided on the lamp body is sandwiched between the gear portion and the engagement portion so that the aiming screw is supported by the gear supporting portion so as to be turnable and restricted in axial translation.

9. The vehicular headlamp according to claim 8, wherein
the lamp body includes a tool insertion portion having an insertion hole for enabling aiming adjustment, through which a tool to be engaged with the gear portion to turn the aiming screw can be inserted from the front.

10. The vehicular headlamp according to claim 9, wherein
the insertion hole is open toward the front so that at least part of the gear portion can be seen from the front.
